(19) United States
(12) Patent Application Publication
(10) Pub. No.: US 2012/0046160 A1
(43) Pub. Date: Feb. 23, 2012

(54) CONVERSION OF TRIGLYCERIDES TO HYDROCARBONS BY MEANS OF A MIXED OXIDE CATALYST

(76) Inventors: Mark Crocker, Georgetown, KY (US); Tonya Morgan, Georgetown, KY (US)

(21) Appl. No.: 12/859,479

(22) Filed: Aug. 19, 2010

(51) Int. Cl. B01J 27/236

(52) U.S. Cl. 502/176

(57) ABSTRACT

A mixed oxide catalyst is prepared by precipitating a Ni/Al layered double hydroxide having a general formula [NiₓAl_{y}(OH)₂](CO₃)_{y/2}. mH₂O where x+y=1 and m=about 0.5. The Ni/Al layered double hydroxide is aged and then isolated and heat treated under reducing atmosphere to produce the mixed oxide catalyst.

### TECHNICAL FIELD AND INDUSTRIAL APPLICABILITY OF THE INVENTION

The present invention relates generally to the field of hydrocarbon production and catalysts for that purpose.

### BACKGROUND OF THE INVENTION

Fatty acid methylesters or biodiesel is characterized by good lubricity and high cetane number. Unfortunately, however, biodiesel suffers from various drawbacks such as poor storage stability, unfavorable cold flow properties and engine compatability issues. As a result, there is interest in the conversion of vegetable oils and animal fats to hydrocarbon fuels as an alternative to biodiesel. Various methods are known in the art for this purpose including thermal cracking (pyrolysis), acid cracking, and hydroprocessing (hydrotreating). Examples of these processes may be found in, for example, U.S. Pat. No. 4,992,605 to Craig et al., U.S. Pat. No. 5,233,109 to Chow, and U.S. Patent Application Publication No. 2007/0068848 to Monier et al.

Generally, thermal cracking and acid cracking methods or processes are unselective with the consequence that a wide variety of products are formed including light products which are typically of low economic value.

U.S. Pat. No. 7,491,858 to Merzen et al discloses a method for converting triglycerides to hydrocarbons boiling in the jet/diesel fuel range (C₁₀-C₁₇) by means of decarboxylation/decarbonylation using a Group VIII based catalyst. This is done while minimizing the consumption of hydrogen. The catalyst is disclosed as being supported on oxides, mesoporous materials or carbonaceous supports. Palladium and platinum are identified as the preferred catalysts that achieve the best results. Unfortunately, palladium and platinum are very expensive. Furthermore, while Pd supported on carbon is identified as being a particularly good catalyst, the use of carbonaceous supports is problematical in that the regeneration of industrial catalysts typically requires thermal treatment in air to combust accumulated carbonaceous species on the catalytically active sites, a process that would also be expected to result in combustion of the carbon support and destruction of the catalyst.

The present invention relates to a new and improved mixed oxide catalyst of nickel and aluminum that is relatively easy and inexpensive to produce but provides performance heretofore only exhibited by more expensive palladium and platinum catalysts.

### SUMMARY OF THE INVENTION

In accordance with the purposes of the present invention as described herein, a catalyst is provided. The catalyst comprises a material resulting from a process including the step of precipitating an Ni/Al layered double hydroxide at a temperature of between about 1° to about 100° C. wherein said Ni/Al layered double hydroxide has a general formula [NiₓAl_{y}(OH)₂](CO₃)_{y/2}. mH₂O where x+y=1 and m=about 0.5. The process further includes the aging of the Ni/Al layered double hydroxide at a temperature of between about 1° and about 100° C. for a time period of between about 1 and about 24 hours. Further, the method includes the isolating of the Ni/Al layered double hydroxide following aging and the treating of the Ni/Al layered double hydroxide under a reducing atmosphere at a temperature of between about 250° and about 800° C. for a time period of between about 0.5 and about 12 hours. The process may also include the optional step of calcining the Ni/Al layered double hydroxide at a temperature of between about 150° to about 800° C. for a time period of between about 0.5 and about 12 hours after isolating and prior to treating.

More specifically describing the catalyst, the Ni/Al atomic ratio is between about 0.9:0.1 and about 0.5:0.5 and more preferably between about 0.8:0.2 and about 0.65:0.35. Further, the precipitating step includes adding a first aqueous solution of a salt of Ni and a salt of Al to a second aqueous solution of Na₂CO₃ and NaOH wherein the second aqueous solution has a final pH after addition of about pH 13. The adding of the first aqueous solution is done dropwise and vigorous stirring is maintained during the adding process.

In accordance with an additional aspect of the present invention a process is provided for preparing a catalyst. The process comprises the steps of precipitating a Ni/Al layered double hydroxide at a temperature of between about 1° to about 100° C., aging the Ni/Al layered double hydroxide at a temperature of between about 1° to about 100° C. for a time period of between about 1 and about 24 hours, isolating the Ni/Al layered double hydroxide following aging and treating the Ni/Al layered double hydroxide under a reducing atmosphere at a temperature of between about 250° and about 800° C. for a time period of between about 0.5 and about 12 hours. Further, the process may include the optional step of calcining the Ni/Al layered double hydroxide at a temperature of between about 100° to about 800° C. for a time period of between about 0.5 and about 12 hours after aging and prior to treating. As described above, the Ni/Al layered double hydroxide has a general formula [NiₓAl_{y}(OH)₂](CO₃)_{y/2}. mH₂O where x+y=1 and m=about 0.5.

Further describing the invention, the isolating step is performed by a cycle of (a) a centrifuging, (b) decanting and (c) washing with the ionized water until the washing obtains a neutral pH.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### DETAILED DESCRIPTION OF THE PREFERRED EMBODIMENTS OF THE INVENTION

The catalyst of the present invention comprises a material resulting from a multi-step process. That process includes the precipitating of a Ni/Al layered double hydroxide at a temperature of between about 1° to about 100° C. and typically room temperature, wherein the Ni/Al layered double hydroxide has a general formula [NiₓAl_{y}(OH)₂](CO₃)_{y/2}. mH₂O where x+y=1 and m=about 0.5. The Ni/Al atomic ratio may be broadly described as falling between about 0.9:0:1 and about 0.5:0.5 and more narrowly as falling between about 0.8:0.2 and 0.65:0.35. This is accomplished by using Ni salt and Al salt starting materials at an atomic ratio of Ni to Al of about 2:1 to about 4:1. The precipitating step may be more specifically described as including adding a first aqueous solution of a salt of Ni and a salt of Al to a second aqueous solution of Na₂CO₃ and NaOH wherein the pH of the solution at the end of addition is about pH 13. In accordance with one possible approach the adding of the first aqueous solution is done dropwise and vigorous stirring is maintained during the adding process.

Ni(NO₃)₂ and Al(NO₃)₃ are two salts useful as starting materials in the production of the catalyst of the present invention. They are cheap and have good water solubility. That said, in principle, any salts of Ni and Al may be used including, for example, metal halides, acetates, carbonates and sulfates.

The Na₂CO₃ provides charge balancing ions in the layered double hydroxide. However, it should be appreciated that nitrate, halide, sulfate, acetate and other known anions could be substituted for the carbonate anion in this compound. In addition, KOH or other compounds capable of providing hydroxide anions could be substituted for the NaOH in the process solution.

After precipitating the Ni/Al layered double hydroxide, the method includes the aging of that Ni/Al layered double hydroxide at a temperature of between about 1° and about 100° C. and, typically, at about room temperature for a period of time of between about 1 and about 24 hours. This is followed by the isolating of the Ni/Al layered double hydroxide. More specifically, the isolating may be performed by a cycle of (a) centrifuging, (b) decanting and (c) washing with ionized water until the washing attains a neutral pH.

After the Ni/Al layered double hydroxide has been isolated, it is treated under a reducing atmosphere at a temperature of between about 250° and about 800° C. for a time period of between about 0.5 and about 12 hours. The reducing atmosphere preferably contains hydrogen. In one particularly useful embodiment the treating step is completed at 350° C. for about 2.5 to about 3.5 hours and more typically about 3 hours.

In accordance with an additional aspect of the present invention, the process may include the optional step of calcining the Ni/Al layered double hydroxide at a temperature of between about 150° to about 800° C. for a time period of between about 0.5 and about 12 hours after isolating and prior to treating. Typically, the calcining is completed at a temperature of about 450° C. for about 2.5 to about 3.5 hours and most typically about 3 hours.

Here it should be noted that the treating and optional calcining steps are both thermal treatments that decompose the Ni/Al layered double hydroxide into mixed oxides of Ni and Al. More specifically, the layered double hydroxide contains atomically dispersed ions of Ni and Al that are transformed by thermal activation/reduction into mixed oxides which essentially comprise a solid solution of NiO and Al₂O₃. Some fraction of the NiO, undergoes reduction to metallic Ni. Thus, the resulting catalyst consists of highly porous NiO—Al₂O₃ which contains small Ni nanoparticles dispersed over the external and internal surface (pores) of the mixed oxide particles. Advantageously, the process allows for good dispersion of metallic Ni nanoparticles even at high nickel loading (ie. Ni loading equal to or greater than 30%).

The mixed oxide catalyst that results from the process exhibits good mechanical properties and catalytic activity so as to be useful in the conversion of triglycerides to hydrocarbons. Further, the catalyst may be readily regenerated by heating without any substantial damage to the underlying matrix. Thus, it should be appreciated that the catalysts may be used to efficiently and effectively convert, for example, triglycerides and fatty acids including, but not limited to, those constituting vegetable oils, algal oils, and animal fats, to hydrocarbon fuels including particularly hydrocarbons boiling in the jet/diesel fuel range (e.g., C₁₀-C₁₇).

The following synthesis and examples are presented to further illustrate the invention but is not to be considered as limited thereto.

### EXAMPLE 1

Preparation of Ni—Al LDH Catalyst

A solution of Ni(NO₃)₂.6H₂O and Al(NO₃)₃.9H₂O (0.2 mol total metals) in 210 ml deionized water was added dropwise at room temperature to 330 ml of an aqueous solution containing Na₂CO₃ (30 g, 0.28 mol) and NaOH (48.6 g, 0.46 mol). Vigorous stirring was maintained throughout the 60 min addition period. The resulting precipitate was left to age in the reaction mixture under gentle stirring at 75° C. overnight and was subsequently isolated by a cycle of centrifuging/decanting/washing with deionized water until the washings attained a neutral pH. The resulting solid was dried at 60° C. in a vacuum oven. Prior to use, the catalyst was reduced in situ under flowing H₂ or 10% H₂/N₂ (350° C., 3 h).

Deoxygenation Experiments

Reactions were performed in a mechanically stirred 100 mL stainless steel autoclave equipped with a heating mantle, bubbler and a condensation trap maintained at −78° C. The reactor was designed for semi-batch (i.e., continuous flow) operation and was continuously purged with gas (H₂, 10% H₂/N₂ or N₂, as appropriate) delivered through a mass flow controller. A back pressure regulator maintained the pressure in the reactor at a pre-set value. The reaction temperature was measured by a type-K Omega thermocouple placed inside the reactor body. The stirrer speed was set to 1000 rpm.

(i) Stearic acid: 0.4 g of catalyst was placed in the autoclave. After pretreatment of the catalyst under flowing H₂ or H₂/N₂, stearic acid (1.8 g) was fed into the reactor together with dodecane (34 g) as solvent. The temperature was then raised to 300° C. and held for 90 minutes. The selected gas (H₂, N₂, 10% H₂/N₂) was flowed through the reactor at a rate of 60 ml/min and the gas pressure within the reactor was maintained at 130 psi. Throughout the reaction, the effluent gas was periodically analyzed by GC. At the end of the experiment, the liquid and catalyst were removed and separated by filtration. Additional liquid product was recovered from the catalyst by washing with chloroform.

(ii) Glycerol tristearate: The deoxygenation of glycerol tristearate was performed using catalyst (0.4 g), glycerol tristearate (1.8 g) and dodecane (22 g), according to the same general procedure described above for stearic acid. However, different process conditions were applied; specifically, the temperature was maintained at 360° C. for 360 minutes and the gas pressure within the reactor was maintained at 580 psi.

Decarboxylation of Ethyl Stearate

The deoxygenation of ethyl stearate was performed using catalyst (0.5 g), ethyl stearate (24 g) and dodecane (20 g), according to the same general procedure described for stearic acid. The temperature was maintained at 360° C. for 90 minutes and the gas pressure within the reactor was maintained at 400 psi.

Product Analysis

An Agilent 3000A Micro-GC Refinery Gas Analyzer equipped with 5 Å molecular sieve, PoraPLOT U, alumina and OV-1 columns was used for the analysis of gaseous products. Simulated distillation-GC analyses were performed according to ASTM D2887, using an HP6890 GC equipped with a J&W Scientific D-2887 capillary column. Samples were diluted with chloroform, typically in a 1:10 weight ratio. GC/MS analysis of the oil product was performed using an Agilent 7890A GC coupled to an Agilent 5975C Inert MSD with a triple axis detector. All samples were diluted 10:1 in chloroform and 1 μL of the diluted sample was injected onto a Zebron ZB-1HT Inferno column. The initial oven temperature was set at 35° C. after which it was ramped to 350° C. at 15° C./min. The column was held at the final temperature of 350° C. for 2 min. Zone temperatures, including MS Source (230° C.) and MS Quad (150° C.), remained constant for the duration of the analysis. The mass spectrometer scanned from 10 to 700 Da in 0.5 s. The results are presented below in Tables 1, 2 and 3.

TABLE 1

| | | | | | Conver- | Selectivity |
|---|---|---|---|---|---|---|
| | | | | | sion | to C10-C17 |
| Catalyst | Feed | Time | Temp | Gas | (%) | (%) |
| Ni—Al | Stearic | 90 min | 300° C. | N₂ | 68 | >99 |
| LDH | acid | | | | | |
| Ni—Al | Stearic | 90 min | 300° C. | 10%H₂/ | 77 | >99 |
| LDH | acid | | | N₂ | | |
| Ni—Al | Stearic | 90 min | 300° C. | H₂ | 83 | >99 |
| LDH | acid | | | | | |

TABLE 2

| | | | | | Conver- | Selectivity |
|---|---|---|---|---|---|---|
| | | | | | sion | to C10-C17 |
| Catalyst | Feed | Time | Temp | Gas | (%) | (%) |
| Ni—Al | Glycerol | 360 min | 360° C. | H₂ | 80 | 61 |
| LDH | tristearate | | | | | |
| Ni—Al | Glycerol | 360 min | 360° C. | 10%H₂/ | 81 | 84 |
| LDH | tristearate | | | N₂ | | |

TABLE 3

| | | | | | Conver- | Selectivity |
|---|---|---|---|---|---|---|
| | | | | | sion | to C10-C17 |
| Catalyst | Feed | Time | Temp | Gas | (%) | (%) |
| Ni—Al | Ethyl | 90 min | 360° C. | H₂ | 51 | 88 |
| LDH | stearate | | | | | |

### EXAMPLE 2

Preparation of Ni—Al LDH Catalyst

A solution of Ni(NO₃)₂.6H₂O and Al(NO₃)₃.9H₂O (0.2 mol total metals) in 210 ml deionized water is added dropwise at room temperature to 330 ml of an aqueous solution containing Na₂CO₃ (30 g, 0.28 mol) and NaOH (48.6 g, 0.46 mol). Vigorous stirring is maintained throughout the 60 min addition period. The resulting precipitate is left to age in the reaction mixture under gentle stirring at 75° C. overnight and is subsequently isolated by a cycle of centrifuging/decanting/washing with deionized water until the washings attained a neutral pH. The resulting solid is dried at 60° C. in a vacuum oven. The dried and isolated solid is then calcined in air at 450° C. for 3 hours. Prior to use, the catalyst is reduced in situ under flowing H₂ or 10% H₂/N₂ (350° C., 3 h).

### EXAMPLE 3

To measure the amount of exposed reduced nickel atoms in the catalysts, H₂ chemisorption was performed. Prepared catalysts were calcined in air at 450° C. for 3 h and then reduced under flowing H₂ at 350° C. for 1 h in the chemisorption apparatus. Samples were then purged with argon at 400° C. for 15 min to remove adsorbed hydrogen and cooled to room temperature. Pulsed H₂ chemisorption was then performed by pulsing 0.5 ml of 10% H₂/Ar through the samples every 2 min, the H₂ signal at the reactor outlet being monitored with a thermal conductivity detector (TCD). H₂ pulsing was terminated after the TCD signal had reached a constant value, i.e., the exposed Ni(0) sites were saturated with H₂. Assuming a 1:1 ratio of atomic hydrogen to surface Ni, the number of exposed Ni atoms was calculated based on the amount of H adsorbed. The results are summarized below.

| | Number of exposed |
|---|---|
| Catalyst | Ni⁰ atoms/g |
| LDH-derived Ni-Al catalyst | 1.36 × 10¹⁸ |
| 20 wt % Ni/Al₂O₃ | 2.05 × 10¹⁸ |
| 40 wt % Ni/Al₂O₃ | 6.00 × 10¹⁸ |

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A catalyst comprising a material resulting from a process of:
precipitating a Ni/Al layered double hydroxide at a temperature of between about 1 to about 100° C. wherein said Ni/Al layered double hydroxide has a general formula [NiₓAl_{y}(OH)₂](CO₃)_{y/2}. mH₂O where x+y=1 and m=about 0.5;
aging the Ni/Al layered double hydroxide at a temperature of between about 1 and about 100° C. for a time period of between about 1 and about 24 hours;
isolating the Ni/Al layered double hydroxide following aging; and
treating the Ni/Al layered double hydroxide under a reducing atmosphere at a temperature of between about 250 and about 800° C. for a time period of between about 0.5 and about 12 hours.

2. The catalyst of claim 1, wherein said process further includes calcining the Ni/Al layered double hydroxide at a temperature of between about 150 to about 800° C. for a time period of between about 0.5 and about 12 hours after isolating and prior to treating.

3. The catalyst of claim 1, wherein said Ni/Al atomic ratio is between about 0.9:0.1 and about 0.5:0.5.

4. The catalyst of claim 1, wherein said Ni/Al atomic ratio is between about 0.8:0.2 and about 0.65:0.35.

5. The catalyst of claim 1, wherein said precipitating includes adding a first aqueous solution of a salt of Ni and a salt of Al to a second aqueous solution of Na₂CO₃ and NaOH wherein pH of solution at end of addition is about pH 13.

6. The catalyst of claim 5, wherein said adding is done dropwise and vigorous stirring is maintained during said adding.

7. The catalyst of claim 1, wherein said isolating is performed by a cycle of (a) centrifuging, (b) decanting and (c) washing with deionized water until the washing attains a neutral pH.

8. A process for preparing a catalyst, comprising:
precipitating a Ni/Al layered double hydroxide at a temperature of between about 1 to about 100° C. wherein said Ni/Al layered double hydroxide has a general formula [NiₓAl_{y}(OH)₂](CO₃)_{y/2}. mH₂O where x+y=1 and m=about 0.5;
aging the Ni/Al layered double hydroxide at a temperature of between about 1 and about 100° C. for a time period of between about 1 and about 24 hours;
isolating the Ni/Al layered double hydroxide following aging; and
treating the Ni/Al layered double hydroxide under a reducing atmosphere at a temperature of between about 250 and about 800° C. for a time period of between about 0.5 and about 12 hours.

9. The process of claim 8 further including calcining the Ni/Al layered double hydroxide at a temperature of between about 150 to about 800° C. for a time period of between about 0.5 and about 12 hours after isolating and prior to treating.

10. The process of claim 9, including performing said precipitating at room temperature.

11. The process of claim 10, including performing said aging at room temperature.

12. The process of claim 11, wherein said precipitating includes adding a first aqueous solution of a salt of Ni and a salt of Al to a second aqueous solution of Na₂CO₃ and NaOH wherein pH of solution at end of addition is about pH 13.

13. The process of claim 12, wherein said adding is done dropwise and vigorous stirring is maintained during said adding.

14. The process of claim 13, wherein said isolating is performed by a cycle of (a) centrifuging, (b) decanting and (c) washing with deionized water until the washing attains a neutral pH.

15. The process of claim 8, including performing said treating step at about 350° C. for about 2.5 to about 3.5 hours.

16. The process of claim 14, including performing said treating step at about 350° C. for about 2.5 to about 3.5 hours.

17. The process of claim 16, including performing said calcining at a temperature of about 450° C. for about 2.5 to about 3.5 hours.

18. The process of claim 17, including using Ni(NO₃)₂ and Al(NO₃)₃ as starting materials at an atomic ratio of Ni to Al of about 2:1 to about 4:1.
